(19) United States
(12) Patent Application Publication
(10) Pub. No.: US 2026/0119213 A1
(43) Pub. Date: Apr. 30, 2026

(54) CONTENT ITEM ICONS WITH EVENT INDICATORS

(71) Applicant: Snap Inc., Santa Monica, CA (US)

(72) Inventor: Suraya Shivji, New York, NY (US)

(21) Appl. No.: 18/927,381

(22) Filed: Oct. 25, 2024

(51) Int. Cl. G06F 9/451; G06F 9/54

(52) U.S. Cl. CPC G06F 9/453; G06F 9/542

(57) ABSTRACT

Examples relate to systems and methods for generating icons based on events. The systems and methods receive a content item from a first user system comprising a digital effect associated with an event and determine whether an event condition is satisfied. The systems and methods, based on determining whether the event condition is satisfied, automatically modify an icon that notifies a second user system about the content item to include an event indicator. The systems and methods, in response to receiving input from the second user system that selects the icon, present the content item comprising the digital effect associated with the event on the second user system.

### TECHNICAL FIELD

The present disclosure relates to computer graphics technologies, specifically to methods and systems for dynamically modifying user interface elements to enhance user engagement during holiday periods.

### BACKGROUND

Social media platforms commonly employ visual indicators or icons to alert users about new or updated content from other users. These icons serve as efficient, non-intrusive notifications that draw attention to fresh information without disrupting the user experience.

These indicators appear alongside or overlaid on profile pictures, content thumbnails, or dedicated notification areas within the application interface. Icons used for this purpose often take the form of small, colorful shapes or symbols that stand out. Common examples include dots, rings, or numerical badges. The presence of these icons quickly communicates to users that there is new content available for viewing, encouraging engagement and interaction within the platform. By utilizing such visual cues, social media applications can effectively guide users'attention to recently generated content, fostering a sense of real-time connection and encouraging frequent check-ins.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a digital interaction system that has both client-side and server-side functionality, according to some examples.

FIG. 3 is a diagrammatic representation of a data structure as maintained in a database, according to some examples.

FIG. 4 illustrates an example database used by the event notification component, according to some examples.

FIG. 5 is a diagrammatic representation of a message, according to some examples.

FIG. 6 illustrates a user interface of the digital effects experience generation system, according to some examples.

FIG. 7 illustrates graphical user interfaces generated by the event notification component, according to some examples.

FIG. 8 is a flowchart illustrating a routine (e.g., a method or process), according to some examples.

FIG. 9 illustrates a system including the head-wearable apparatus, according to some examples.

FIG. 10 is a diagrammatic representation of a machine in the form of a computer system within which a set of instructions may be executed to cause the machine to perform any one or more of the methodologies discussed herein, according to some examples.

FIG. 11 is a block diagram showing a software architecture within which examples may be implemented.

### DETAILED DESCRIPTION

The description that follows discusses illustrative examples of the disclosure. In the following description, for the purposes of explanation, numerous specific details are set forth to provide an understanding of various examples of the disclosed subject matter. It will be evident, however, to those skilled in the art, that examples of the disclosed subject matter may be practiced without these specific details. In general, well-known instruction instances, protocols, structures, and techniques are not necessarily shown in detail.

In typical social media applications, notification systems commonly employ visual indicators or icons to alert users about new content or updates from other users or friends on the social media applications. These notifications usually appear as small, distinctive elements such as dots, rings, or numerical badges overlaid on profile pictures, content thumbnails, or within dedicated notification areas of the interface. The purpose of these icons is to quickly draw users'attention to fresh content without disrupting their overall experience, thereby encouraging engagement and frequent interaction with the platform.

However, while serving a basic purpose, these conventional notification systems often suffer from several inefficiencies and waste resources in various ways. Many systems use a one-size-fits-all approach, employing uniform visual indicators regardless of content relevance or context. This can lead to information overload, potentially causing users to become desensitized to notifications and miss important updates. Traditional notification systems often lack contextual awareness, failing to consider factors such as time of day, special occasions, or cultural events relevant to the user. This missed opportunity to tailor the user experience results in less engaging and less personalized interactions with the platform.

Furthermore, conventional systems frequently update notification icons in a predetermined, rigid manner. This approach fails to capitalize on the potential for dynamic, event-driven updates that could more effectively capture users' attention and boost engagement. Many existing notification systems also inefficiently utilize the limited screen real-estate available on mobile devices, relying on small, generic icons that may not effectively convey the nature or importance of new content. This can lead to users having to navigate through multiple screens or perform additional actions to discern the relevance of notifications, resulting in a less streamlined user experience. These inefficiencies collectively contribute to a suboptimal use of system resources and missed opportunities for enhancing user engagement, particularly during periods of heightened social activity such as holidays or special events.

The disclosed examples improve the efficiency of using the electronic device by providing dynamic, context-aware notification icons that adapt to specific holidays and events. The disclosed techniques enhance user engagement by transforming the standard notification icons, such as rings or circular icons, into a visually appealing, holiday-themed or event-themed indicators for a specified period (e.g., a 24-hour period) when users post content using holiday-related or event-related digital effects, such as augmented reality experiences and digital event stickers. By changing the icon appearance to reflect the current holiday or event, the disclosed techniques create a more personalized and immersive experience, effectively capturing users'attention during periods of heightened social activity. The disclosed techniques efficiently utilize screen real-estate by conveying additional information through subtle visual changes, eliminating the need for users to navigate through multiple screens to discern the relevance of new content. Furthermore, the disclosed techniques are able to automatically revert to normal presentation of the icons after the specified period of the event or holiday to ensure that the special indicators remain timely and impactful, avoiding notification fatigue and maintaining user interest in the platform's holiday-themed and event-themed features.

For example, the disclosed techniques generate icons based on events. The disclosed techniques receive a content item from a first user system including a digital effect associated with an event (or holiday) and determine whether an event condition is satisfied. The disclosed techniques, based on determining whether the event condition is satisfied, automatically modify an icon that notifies a second user system about the content item to include an event indicator. The disclosed techniques, in response to receiving input from the second user system that selects the icon, present the content item including the digital effect associated with the event on the second user system.

As a result, one or more of the methodologies described herein facilitate solving the technical problem of content notifications presented by conventional methods. As such, one or more of the methodologies described herein obviate a need for certain efforts or computing resources that otherwise would be involved in providing content notifications. As a result, resources used by one or more machines, databases, or devices (e.g., within the environment) are reduced. Examples of such computing resources include processor cycles, network traffic, memory usage, data storage capacity, power consumption, network bandwidth, and cooling capacity. Also, the disclosed techniques provide an improved graphical user interface that reduces the number of screens a user has to navigate to obtain information about other users which can only be performed on a computing device.

### Networked Computing Environment

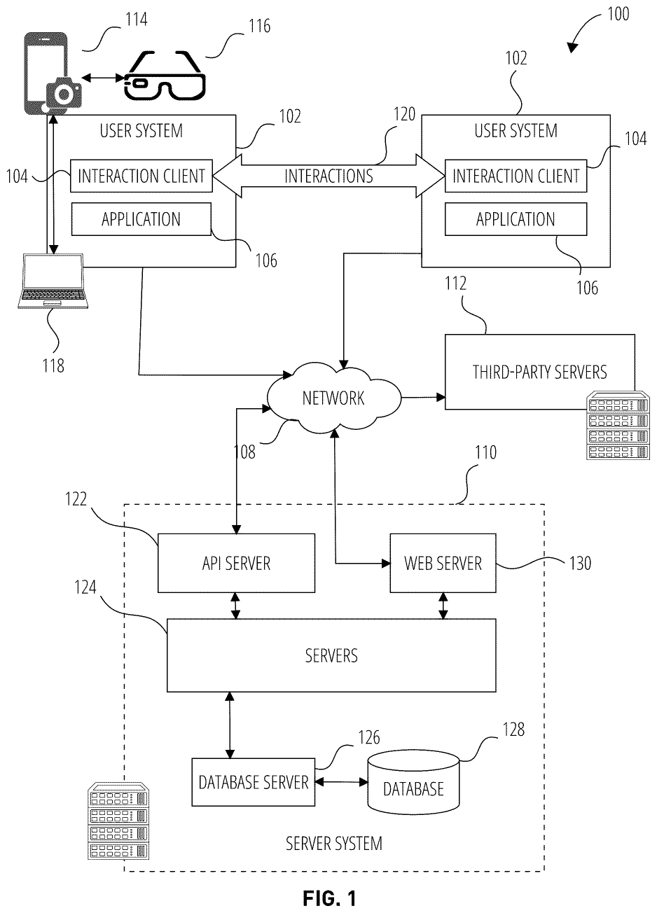

FIG. 1 is a block diagram showing an example digital interaction system 100 for facilitating interactions and engagements (e.g., exchanging text messages, conducting text audio and video calls, or playing games) over a network. The digital interaction system 100 includes multiple user systems 102 (e.g., user devices) and/or head-wearable apparatus 116, each of which hosts multiple applications, including an interaction client 104 and other applications 106. Each interaction client 104 is communicatively coupled, via one or more networks including a network 108 (e.g., the Internet), to other instances of the interaction client 104 (e.g., hosted on respective other user systems 102), a server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the server system 110 via the network 108. The data exchanged between the interaction clients 104 (e.g., interactions 120) and between the interaction clients 104 and the server system 110 includes functions (e.g., commands to invoke functions) and payload data (e.g., text, audio, video, or other multimedia data).

The server system 110 provides server-side functionality via the network 108 to the interaction clients 104. While certain functions of the digital interaction system 100 are described herein as being performed by either an interaction client 104 or by the server system 110, the location of certain functionality either within the interaction client 104 or the server system 110 may be a design choice. For example, it may be technically preferable to initially deploy particular technology and functionality within the server system 110 but to later migrate this technology and functionality to the interaction client 104 where a user system 102 has sufficient processing capacity.

The server system 110 supports various services and operations that are provided to the interaction clients 104. Such operations include transmitting data to, receiving data from, and processing data generated by the interaction clients 104. This data may include message content, client device information, geolocation information, digital effects (e.g., media augmentation and overlays), message content persistence conditions, entity relationship information, and live event information. Data exchanges within the digital interaction system 100 are invoked and controlled through functions available via user interfaces (UIs) of the interaction clients 104.

Turning now specifically to the server system 110, an Application Program Interface (API) server 122 is coupled to and provides programmatic interfaces to servers 124, making the functions of the servers 124 accessible to interaction clients 104, other applications 106 and third-party server 112. The servers 124 are communicatively coupled to a database server 126, facilitating access to a database 128 that stores data associated with interactions processed by the servers 124. Similarly, a web server 130 is coupled to the servers 124 and provides web-based interfaces to the servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the servers 124. The Application Program Interface (API) server 122 exposes various functions supported by the servers 124, including account registration; login functionality; the sending of interaction data, via the servers 124, from a particular interaction client 104 to another interaction client 104; the communication of media files (e.g., images or video) from an interaction client 104 to the servers 124; the settings of a collection of media data (e.g., a narrative); the retrieval of a list of friends of a user of a user system 102; the retrieval of messages and content; the addition and deletion of entities (e.g., friends) to an entity relationship graph (e.g., the entity graph 308); the location of friends within an entity relationship graph; and opening an application event (e.g., relating to the interaction client 104).

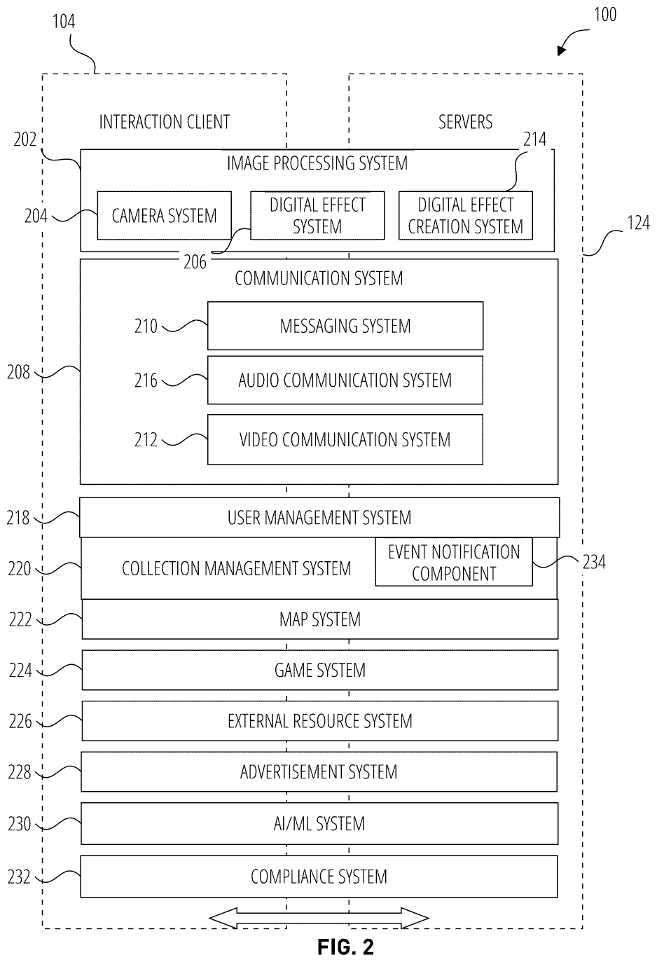

The servers 124 host multiple systems and subsystems, described below with reference to FIG. 2.

### External Resources and Linked Applications

The interaction client 104 provides a user interface that allows users to access features and functions of an external resource, such as a linked application 106, an applet, or a microservice. This external resource may be provided by a third party or by the creator of the interaction client 104.

The external resource may be a full-scale application installed on the user's system 102, or a smaller, lightweight version of the application, such as an applet or a microservice, hosted either on the user's system or remotely, such as on third-party servers 112 or in the cloud. These smaller versions, which include a subset of the full application's features, may be implemented using a markup-language document and may also incorporate a scripting language and a style sheet.

When a user selects an option to launch or access the external resource, the interaction client 104 determines whether the resource is web-based or a locally installed application. Locally installed applications can be launched independently of the interaction client 104, while applets and microservices can be launched or accessed via the interaction client 104.

If the external resource is a locally installed application, the interaction client 104 instructs the user's system to launch the resource by executing locally stored code. If the resource is web-based, the interaction client 104 communicates with third-party servers to obtain a markup-language document corresponding to the selected resource, which it then processes to present the resource within its user interface.

The interaction client 104 can also notify users of activity in one or more external resources. For instance, it can provide notifications relating to the use of an external resource by one or more members of a user group. Users can be invited to join an active external resource or to launch a recently used but currently inactive resource.

The interaction client 104 can present a list of available external resources to a user, allowing them to launch or access a given resource. This list can be presented in a context-sensitive menu, with icons representing different applications, applets, or microservices varying based on how the menu is launched by the user.

In some cases, the external resources include applications that enable shared or multiplayer digital effect applications or experiences and sessions on one or more head-wearable apparatuses 116, as discussed below. In some examples, the external resources include instructions that define functionality to implement respective digital effects experiences. These instructions can include textual prompts that are processed by local or remote implementations of generative machine learning models to generate the digital effects experiences, such as by presented artificially generated or artificially augmented video with one or more digital effects.

### System Architecture

FIG. 2 is a block diagram illustrating further details regarding the digital interaction system 100, according to some examples. Specifically, the digital interaction system 100 is shown to comprise the interaction client 104 and the servers 124. The digital interaction system 100 embodies multiple subsystems, which are supported on the client-side by the interaction client 104 and on the server-side by the servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each of the other components through well-defined APIs or interfaces, using lightweight protocols such as REST or messaging. The API interface defines the inputs and outputs of the microservice subsystem and how it interacts with other microservice subsystems of the digital interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the digital interaction system 100.
Service discovery: Microservice subsystems may find and communicate with other microservice subsystems of the digital interaction system 100. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and modify (e.g., augment, annotate or otherwise edit) media content associated with a message.

A camera system 204 includes control software (e.g., in a camera application) that interacts with and controls camera hardware (e.g., directly or via operating system controls) of the user system 102 to modify real-time images captured and displayed via the interaction client 104.

The digital effect system 206 provides functions related to the generation and publishing of digital effects (e.g., media overlays) for images captured in real-time by cameras of the user system 102 or retrieved from memory of the user system 102. For example, the digital effect system 206 operatively selects, presents, and displays digital effects (e.g., media overlays such as image filters or modifications) to the interaction client 104 for the modification of real-time images received via the camera system 204 or stored images retrieved from memory 902 of a user system 102. The digital effect system 206 can provide such functions by accessing a set of instructions associated with each respective digital effects experience and processing such instructions by video generative machine learning models in real time. The generative machine learning models can continuously process inputs and/or interactions with the rendered digital effects experiences to update presentation of the digital effects provided by the digital effects experiences. These digital effects are selected by the digital effect system 206 and presented to a user of an interaction client 104, based on a number of inputs and data, such as for example:
Geolocation of the user system 102; and
Entity relationship information of the user of the user system 102.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212. A digital effect(s) application (or digital effects experience experience) is an application configured to provide and display these digital effects and can enable users to engage in multiplayer digital effects sessions using respective head-wearable apparatuses 116 or other user system 102. The digital effect application can be part of the application 106 (and/or interaction client 104) implemented by the user system 102 and/or the head-wearable apparatus 116. In some cases, the digital effect application or output representing the digital effect application can be rendered by a generative machine learning model by processing a set of instructions including prompts that define behavior, goals, and attributes of digital effects relative to real-world or virtual items presented in a video or image in real time. This way, rather than using SLAM or other real-time object tracking and modeling, the digital effects can be presented using fewer hardware and software resources by processing the instructions and generating outputs with the generative machine learning model.

In some cases, the digital effects that are applied to one or more images, one or more videos, and/or a sequence of videos captured by a user system 102 can be event or holiday based. The system can be enhanced to allow users to select from a curated list of digital effects corresponding to specific events or holidays. This list can be dynamically updated based on the current date and upcoming events, providing users with timely and relevant options for enhancing their content. For instance, as a holiday approaches (e.g., one week before the start time/date of the holiday), the digital effect system 206 can populate the list with digital effects (such as augmented reality experiences or stickers) that are specifically designed for that event (e.g., holiday). Users can then choose from these holiday-themed effects to apply to their images, videos, or video sequences. For example, each digital effect can be represented by a corresponding icon or option. The digital effect system 206 can receive input (before, during, or after the images, videos, or video sequences are captured/generated) that selects one or more of the icons or options. In response, the digital effect system 206 modifies the captured content using the digital effects corresponding to the selected icons or options, such as by overlaying one or more graphical indicators on the captured content.

The time-based aspect of this feature ensures that users are presented with the most appropriate and engaging options. For example, Valentine's Day-themed effects may become available in the list a week or two before February 14th, and remain accessible for a short period after the holiday. This approach maintains the novelty and relevance of the digital effects, encouraging users to engage with holiday-specific content creation. Moreover, the digital effect system 206 can be designed to automatically remove or hide these event-specific digital effects from the list once the relevant time period has passed. This ensures that users are always presented with current and contextually appropriate options, maintaining the freshness and timeliness of the content creation process. By implementing this time-based, event-driven approach to digital effects, the digital effect system 206 can create a more dynamic and engaging user experience, encouraging users to participate in holiday-themed content creation and fostering a sense of community around shared cultural moments.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The digital effect creation system 214 supports augmented reality developer platforms and includes an application for content creators (e.g., artists and developers) to create and publish digital effects (e.g., augmented reality experiences) of the interaction client 104. The digital effect creation system 214 provides a library of built-in features and tools to content creators including, for example custom shaders, tracking technology, and templates. Any functionality that is performed by the digital effect creation system 214 can be replaced and/or augmented by processing instructions with or by a generative machine learning model. In such cases, object tracking and 3D modeling components used by the digital effect creation system 214 can be omitted or skipped as the appropriate output is rendered by the generative machine learning model.

In some examples, the digital effect creation system 214 provides a merchant-based publication platform that enables merchants to select a particular digital effect associated with a geolocation via a bidding process. For example, the digital effect creation system 214 associates a media overlay of the highest bidding merchant with a corresponding geolocation for a predefined amount of time.

A communication system 208 is responsible for enabling and processing multiple forms of communication and interaction within the digital interaction system 100 and includes a messaging system 210, an audio communication system 216, and a video communication system 212. The messaging system 210 is responsible, in some examples, for enforcing the temporary or time-limited access to content by the interaction clients 104. The messaging system 210 incorporates multiple timers that, based on duration and display parameters associated with a message or collection of messages (e.g., a narrative), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 306, entity graphs 308 and profile data 302) regarding users and relationships between users of the digital interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

The collection management system 220 can include an event notification component 234. While the disclosed techniques are discussed in reference to holidays, similar operations and functions are applicable to any type of event having a predefined start time or start date and end time or end date. The event notification component 234 performs several functions to enhance user engagement through dynamic, context-aware notifications. The event notification component 234 manages a curated list of digital effects corresponding to specific events or holidays, which is dynamically updated based on the current date and upcoming events. This ensures users are presented with timely and relevant options for enhancing their content.

As holidays approach, the event notification component 234 populates the list with event-specific digital effects, such as themed lenses or stickers. Users can then select from these options to apply to their images, videos, or video sequences, creating holiday-themed content. The time-based aspect of this feature ensures that users are presented with the most appropriate and engaging options for the current period. The event notification component 234 also handles the automatic removal or hiding of event-specific digital effects from the list once the relevant time period has passed. This maintains the freshness and timeliness of the content creation process, always presenting users with current and contextually appropriate options.

Additionally, the event notification component 234 manages the transformation of standard content notifications into visually appealing, holiday-themed indicators. When users post content using holiday-related digital effects, the event notification component 234 changes the appearance of the corresponding content notification to reflect the current holiday for a specified interval, such as 24-hours before the start time of the event. This creates a more personalized and immersive experience, effectively capturing users'attention during periods of heightened social activity.

The event notification component 234 also ensures that these special indicators remain impactful by automatically reverting them to normal after the specified interval, avoiding notification fatigue and maintaining user interest in the platform's holiday-themed features. By implementing these features, the event notification component 234 creates a more dynamic and engaging user experience, encouraging participation in holiday-themed content creation and fostering a sense of community around shared cultural moments.

The event notification component 234 performs operations to enhance user engagement through dynamic, context-aware notifications. The event notification component 234 receives a content item from a first user system 102 with a digital effect associated with an event and determines whether an event condition is satisfied. Based on this determination, the event notification component 234 automatically modifies an icon to include an event indicator, notifying a second user system about the content item. When the second user system selects the modified icon, the event notification component 234 presents the content item with the event-associated digital effect.

To determine if the event condition is satisfied, the event notification component 234 checks if the current time falls within a threshold period (such as 24 hours) before the event's start time. In some examples, event notification component 234 can also consider geographical regions, identifying multiple events associated with a specific area and retrieving their start times. Once the event condition is no longer satisfied, the event notification component 234 removes the event indicator from the icon. The event notification component 234 manages content items, such as one or more images captured using an image capture device, which can be modified with selected digital effects associated with the event. Alternatively, the event notification component 234 handles a sequence of videos played back in order when accessed on the second user system 102. In some examples, the digital effects managed by the event notification component 234 include augmented reality items or stickers used to modify the images in the content item.

For icon modification, the event notification component 234 generates a circular icon comprising an individual graphical indicator (such as an emoji) adjacent to or on top of the icon. In some examples, the event notification component 234 also adds a ring around the circular icon. The ring includes visual properties corresponding to those of the emoji, such as having the ring be the same or similar color as the emoji. The event notification component 234 can randomly select this graphical indicator from multiple options associated with the event or base the selection on a subscription status of a user's account.

The event notification component 234 can integrate with the user system 102 camera API to allow users to capture images or videos directly within the interaction client 104. In some examples, the event notification component 234 causes display of a selection interface where users can browse and apply event-specific AR filters or stickers. For video sequences, the event notification component 234 implements a custom video player that handles the playback of multiple clips in a predetermined order, with smooth transitions between them. The AR effects are implemented using technologies like ARKit for iOS or ARCore for Android or other technologies, allowing for real-time face tracking and 3D object placement.

In some examples, the event notification component 234 maintains a database of events and their associated digital effects. When a user creates content, the event notification component 234 checks if any applied effects match those in the database. If a match is found, the event notification component 234 flags the content as event-related. The event notification component 234 then checks the current time against the event's scheduled time to determine if the event condition is satisfied. If so, the event notification component 234 modifies the content's notification icon by adding a holiday-specific emoji or changing the ring color around the user's profile picture.

The event notification component 234 uses a time-based scheduler that regularly checks the current time against a list of upcoming events, in some examples. In some examples, the event notification component 234 implements a geofencing feature that associates users with specific geographical regions and tailors the event list accordingly. For example, the event notification component 234 can display Diwali-related effects to users in India while displaying Thanksgiving effects to users in the United States. In some examples, the event notification component 234 uses a countdown timer for each modified icon, automatically reverting it to its original state after the specified period (e.g., 24 hours) has elapsed or when the end time of the event is reached.

In some examples, the event notification component 234 uses a layered approach for icon modification, where the base circular icon (or icon having any other specified geometric shape) is overlaid with additional graphical elements. The event notification component 234 may implement a custom drawing or animation function that adds the emoji or animation indicator and/or colored ring or border. The random selection of emojis can be achieved using a pseudo-random number generator seeded with the user's ID to ensure consistency across sessions. For subscription-based selection, the event notification component 234 maintains a lookup table mapping subscription tiers to sets of available emojis, allowing for more exclusive options for higher-tier subscribers.

The event notification component 234 tracks user engagement metrics, such as the number of event-themed posts created, views of event-modified content, and interaction rates with event-specific features. The event notification component 234 may implement a gamification system that rewards users for participating in holiday-themed activities, such as creating a streak of daily holiday posts or achieving a certain number of views on holiday content. In some examples, the event notification component 234 also facilitates community features like event-specific hashtags or collaborative AR experiences that multiple users can participate in simultaneously, further enhancing the sense of shared cultural moments.

A map system 222 provides various geographic location (e.g., geolocation) functions and supports the presentation of map-based media content and messages by the interaction client 104. For example, the map system 222 enables the display of user icons or avatars (e.g., stored in profile data 302) on a map to indicate a current or past location of “friends” of a user, as well as media content (e.g., collections of messages including photographs and videos) generated by such friends, within the context of a map. For example, a message posted by a user to the digital interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the digital interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the digital interaction system 100. The digital interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and supports the provision of in-game rewards (e.g., coins and items).

An external resource system 226 provides an interface for the interaction client 104 to communicate with remote servers (e.g., third-party servers 112) to launch or access external resources, e.g., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the servers 124. The SDK includes Application Programming Interfaces (APIs) with functions that can be called or invoked by the web-based application. The servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to servers 124. The servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and handles the delivery and presentation of these advertisements.

An artificial intelligence and machine learning system 230 provides a variety of services to different subsystems within the digital interaction system 100. For example, the artificial intelligence and machine learning system 230 operates with the image processing system 202 and the camera system 204 to analyze images and extract information such as objects, text, or faces. This information can then be used by the image processing system 202 to enhance, filter, or manipulate images. The artificial intelligence and machine learning system 230 may be used by the digital effect system 206 to generate modified content and augmented reality experiences, such as adding virtual objects or animations to real-world images. The artificial intelligence and machine learning system 230 can access a set of instructions that define an individual digital effects experience. The artificial intelligence and machine learning system 230 can then process such instructions by a generative machine learning model (in some cases along with additional user supplied inputs and/or videos/images) to render an artificial video that depicts digital effects within a real-world or virtual environment defined by the instructions. The artificial intelligence and machine learning system 230 can continuously process inputs as the artificial video is presented and update a display representing the digital effects experience in real time. This provides the perception to the user that information presented in the video is being tracked and modeled in real time without actually having to operation or user any tracking or modeling components of the user system 102.

Machine learning is a field of study that gives computers the ability to learn without being explicitly programmed. The artificial intelligence and machine learning system 230 can be built using machine learning models. Machine learning (e.g., machine learning models) explores the study and construction of algorithms, also referred to herein as tools, that may learn from existing data and make predictions about new data. Such machine-learning tools operate by building a model from example training data in order to make data-driven predictions or decisions expressed as outputs or assessments. Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms use features for analyzing the data to generate an assessment. Each of the features is an individual measurable property of a phenomenon being observed. The concept of a feature is related to that of an explanatory variable used in statistical techniques such as linear regression. Choosing informative, discriminating, and independent features is important for the effective operation of the pattern recognition, classification, and regression. Features may be of different types, such as numeric features, strings, and graphs.

In one example, the features may be of different types and may include one or more of content, concepts, attributes, historical data, and/or user data, merely for example. The machine-learning algorithms use the training data to find correlations among the identified features that affect the outcome or assessment. In some examples, the training data includes labeled data, which is known data for one or more identified features and one or more outcomes, such as detecting communication patterns, detecting the meaning of the message, generating a summary of a message, detecting action items in messages detecting urgency in the message, detecting a relationship of the user to the sender, calculating score attributes, calculating message scores, detecting an error in an uncorrected gaze vector, etc.

With the training data and the identified features, the machine-learning tool is trained at machine-learning program training. The machine-learning tool appraises the value of the features as they correlate to the training data. The result of the training is the trained machine-learning program. When the trained machine-learning program is used to perform an assessment, new data is provided as an input to the trained machine-learning program, and the trained machine-learning program generates the assessment as output.

The machine-learning program supports two types of phases, namely a training phase and a prediction phase. In training phases, supervised learning, unsupervised learning, or reinforcement learning may be used. For example, the machine-learning program (1) receives features (e.g., as structured or labeled data in supervised learning) and/or (2) identifies features (e.g., unstructured or unlabeled data for unsupervised learning) in training data. In prediction phases, the machine-learning program uses the features for analyzing query data to generate outcomes or predictions (as examples of an assessment).

In the training phase, feature engineering is used to identify features and may include identifying informative, discriminating, and independent features for the effective operation of the machine-learning program in pattern recognition, classification, and regression. In some examples, the training data includes labeled data, which is known data for pre-identified features and one or more outcomes. Each of the features may be a variable or attribute, such as individual measurable property of a process, article, system, or phenomenon represented by a data set (e.g., the training data).

In training phases, the machine-learning program uses the training data to find correlations among the features that affect a predicted outcome or assessment. With the training data and the identified features, the machine-learning program is trained during the training phase at machine-learning program training. The machine-learning program appraises values of the features as they correlate to the training data. The result of the training is the trained machine-learning program (e.g., a trained or learned model).

Further, the training phases may involve machine learning, in which the training data is structured (e.g., labeled during preprocessing operations), and the trained machine-learning program implements a relatively simple neural network capable of performing, for example, classification and clustering operations. In other examples, the training phase may involve deep learning, in which the training data is unstructured, and the trained machine-learning program implements a deep neural network that is able to perform both feature extraction and classification/clustering operations.

A neural network generated during the training phase, and implemented within the trained machine-learning program, may include a hierarchical (e.g., layered) organization of neurons. For example, neurons (or nodes) may be arranged hierarchically into a number of layers, including an input layer, an output layer, and multiple hidden layers. Each of the layers within the neural network can have one or many neurons, and each of these neurons operationally computes a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which defines the influence of the input from a transmitting neuron to a receiving neuron.

In some examples, the neural network may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), a Generative Adversarial Network (GAN), and/or a Recursive Neural Network (RNN), merely for example.

During prediction phases, the trained machine-learning program is used to perform an assessment. Query data is provided as an input to the trained machine-learning program, and the trained machine-learning program generates the assessment as output, responsive to receipt of the query data.

The communication system 208 and messaging system 210 may use the artificial intelligence and machine learning system 230 to analyze communication patterns and provide insights into how users interact with each other and provide intelligent message classification and tagging, such as categorizing messages based on sentiment or topic. The artificial intelligence and machine learning system 230 may also provide chatbot functionality to message interactions 120 between user systems 102 and between a user system 102 and the server system 110. The artificial intelligence and machine learning system 230 may also work with the audio communication system 216 to provide speech recognition and natural language processing capabilities, allowing users to interact with the digital interaction system 100 using voice commands.

A compliance system 232 facilitates compliance by the digital interaction system 100 with data privacy and other regulations, including for example the California Consumer Privacy Act (CCPA), General Data Protection Regulation (GDPR), and Digital Services Act (DSA). The compliance system 232 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 232 also incorporates opt-in/opt-out management and privacy controls across the digital interaction system 100, empowering users to manage their data preferences. The compliance system 232 is designed to handle sensitive data by obtaining explicit consent, implementing strict access controls and in accordance with applicable laws.

### Data Architecture

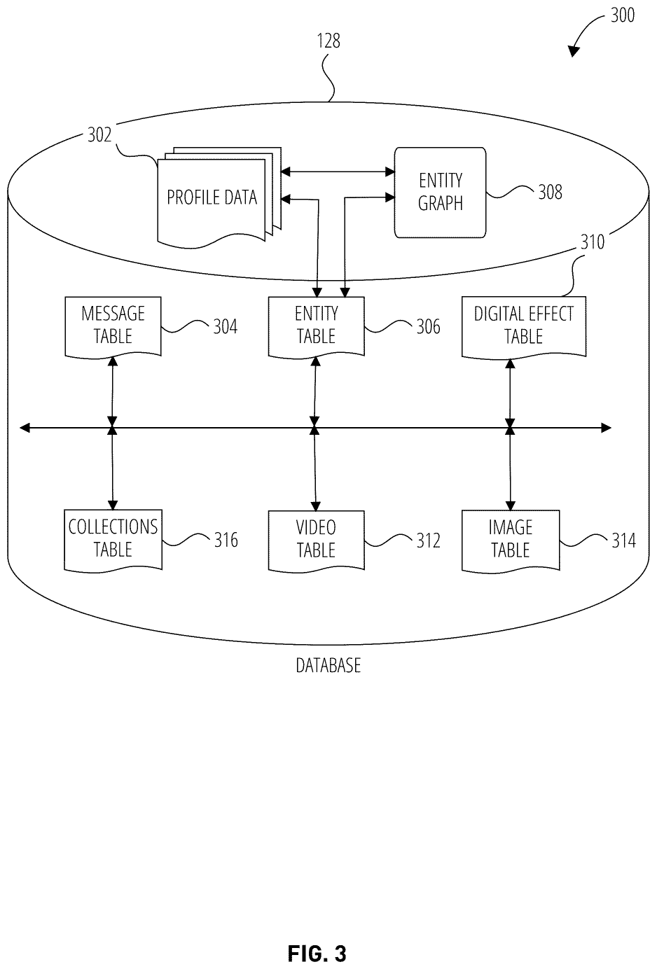

FIG. 3 is a schematic diagram illustrating data structures 300, which may be stored in the database 128 of the server system 110, according to certain examples. While the content of the database 128 is shown to comprise multiple tables, it will be appreciated that the data could be stored in other types of data structures (e.g., as an object-oriented database).

The database 128 includes message data stored within a message table 304. This message data includes at least message sender data, message recipient (or receiver) data, and a payload. Further details regarding information that may be included in a message, and included within the message data stored in the message table 304, are described below with reference to FIG. 3.

An entity table 306 stores entity data, and is linked (e.g., referentially) to an entity graph 308 and profile data 302. Entities for which records are maintained within the entity table 306 may include individuals, corporate entities, organizations, objects, places, events, and so forth. Regardless of entity type, any entity regarding which the server system 110 stores data may be a recognized entity. Each entity is provided with a unique identifier, as well as an entity type identifier (not shown).

The entity graph 308 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the digital interaction system 100.

Certain permissions and relationships may be attached to each relationship, and to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 306. Such privacy settings may be applied to all types of relationships within the context of the digital interaction system 100, or may selectively be applied to certain types of relationships.

The profile data 302 stores multiple types of profile data about a particular entity. The profile data 302 may be selectively used and presented to other users of the digital interaction system 100 based on privacy settings specified by a particular entity. Where the entity is an individual, the profile data 302 includes, for example, a username, telephone number, address, settings (e.g., notification and privacy settings), as well as a user-selected avatar representation (or collection of such avatar representations). A particular user may then selectively include one or more of these avatar representations within the content of messages communicated via the digital interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 302 for the group may similarly include one or more avatar representations associated with the group, in addition to the group name, members, and various settings (e.g., notifications) for the relevant group.

The database 128 also stores digital effect data, such as overlays or filters, in a digital effect table 310. The digital effect data is associated with and applied to videos (for which data is stored in a video table 312) and images (for which data is stored in an image table 314).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other digital effect data (e.g., instructions that define one or more digital effects experiences) that may be stored within the image table 314 includes augmented reality content items (e.g., corresponding to augmented reality experiences). An augmented reality content item may be a real-time special effect and sound that may be added to an image or a video.

A collections table 316 stores data regarding collections of messages and associated image, video, or audio data, which are compiled into a collection (e.g., a narrative or a gallery). The creation of a particular collection may be initiated by a particular user (e.g., each user for which a record is maintained in the entity table 306). A user may create a “personal collection” in the form of a collection of content that has been created and sent/broadcast by that user. To this end, the user interface of the interaction client 104 may include an icon that is user-selectable to enable a sending user to add specific content to his or her personal narrative.

A collection may also constitute a “live collection,” which is a collection of content from multiple users that is created manually, automatically, or using a combination of manual and automatic techniques. For example, a “live collection” may constitute a curated stream of user-submitted content from various locations and events. Users whose client devices have location services enabled and are at a common location event at a particular time may, for example, be presented with an option, via a user interface of the interaction client 104, to contribute content to a particular live collection. The live collection may be identified to the user by the interaction client 104, based on his or her location.

A further type of content collection is known as a “location collection,” which enables a user whose user system 102 is located within a specific geographic location (e.g., on a college or university campus) to contribute to a particular collection. In some examples, a contribution to a location collection may employ a second degree of authentication to verify that the end-user belongs to a specific organization or other entity (e.g., is a student on the university campus).

As mentioned above, the video table 312 stores video data that, in some examples, is associated with messages for which records are maintained within the message table 304.

Similarly, the image table 314 stores image data associated with messages for which message data is stored in the entity table 306. The entity table 306 may associate various digital effects from the digital effect table 310 with various images and videos stored in the image table 314 and the video table 312.

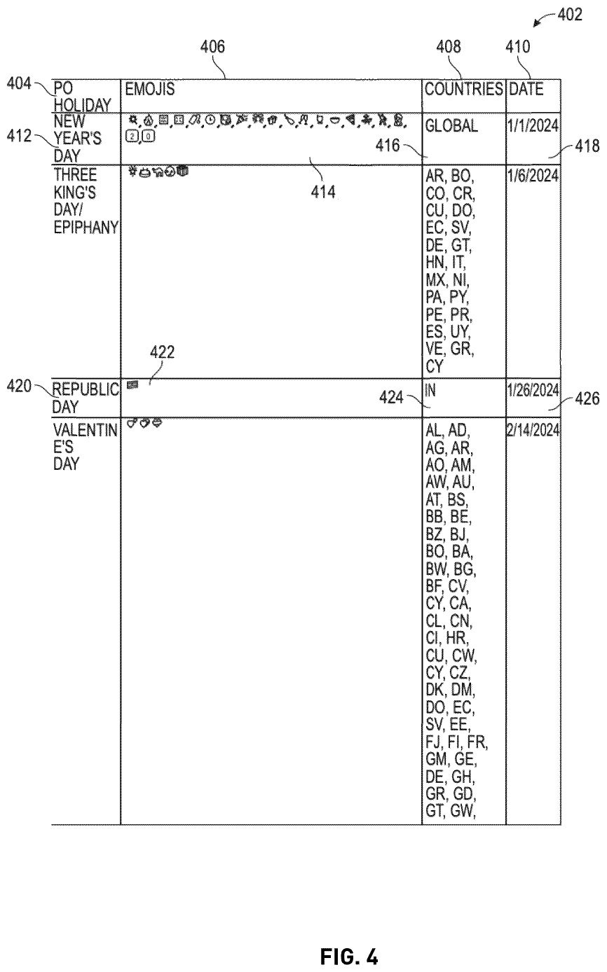

The database 128 can also store the event database 402 shown in FIG. 4. Specifically, FIG. 4 illustrates an event database 402 containing various fields, such as a list of events 404 field along with associated information. Namely, the event database 402 includes several components: the list of events 404 field, a list of graphical indicators 406 field including emojis or graphical indicators associated with each event, a list of geographical regions 408 field indicating the geographical region where each event is celebrated or relevant, and start times 410 field showing the dates/times when each event begins and/or ends.

In some examples, the list of events 404 field includes a first event 412. The first event 412 can be New Year's Day, with multiple fireworks emojis as its first set of graphical indicators 414 stored in the list of graphical indicators 406 field. The first event 412 can be associated with a global geographical region as the first geographical region 416 of the list of geographical regions 408 field and a first start time 418 of Jan. 1, 2024 stored in the start times 410 field. In some cases, the event database 402 stores a second event 420. The second event 420 can be Republic Day, with two flag emojis as its second set of graphical indicators 422, India as its second geographical region 424 and a second start time 426 of Jan. 26, 2024.

This database structure allows the event notification component 234 to efficiently manage and retrieve information about various events, their associated graphical indicators, relevant geographical regions, and start times. This information can be used to customize user experiences and notifications based on specific events and user locations.

### Data Communications Architecture

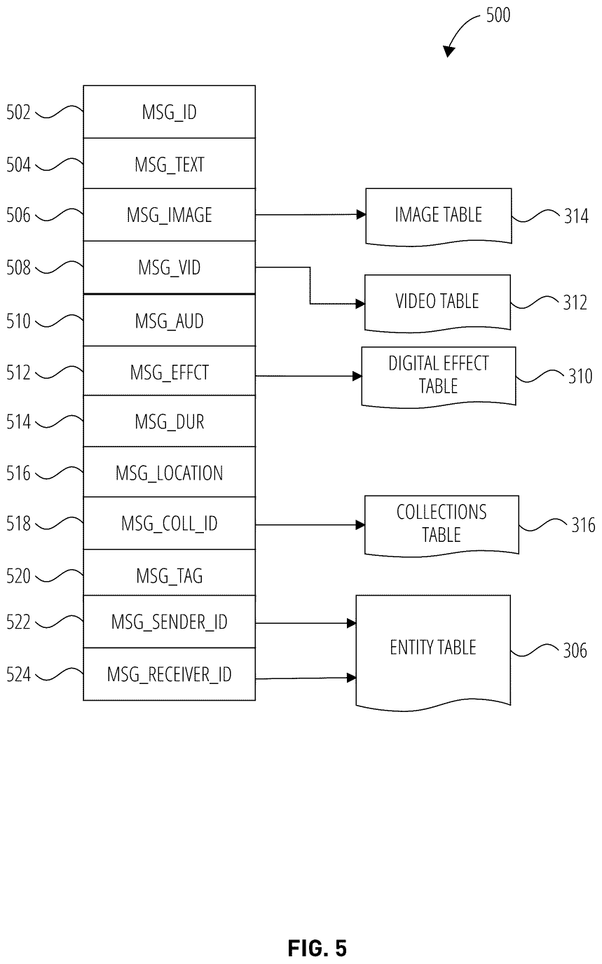

FIG. 5 is a schematic diagram illustrating a structure of a message 500, according to some examples, generated by an interaction client 104 for communication to a further interaction client 104 via the servers 124. The content of a particular message 500 is used to populate the message table 304 stored within the database 128, accessible by the servers 124.

Similarly, the content of a message 500 is stored in memory as “in-transit” or “in-flight” data of the user system 102 or the servers 124. A message 500 is shown to include the following example components:
Message identifier 502: a unique identifier that identifies the message 500.
Message text payload 504: text, to be generated by a user via a user interface of the user system 102, and that is included in the message 500.
Message image payload 506: image data, captured by a camera component of a user system 102 or retrieved from a memory component of a user system 102, and that is included in the message 500. Image data for a sent or received message 500 may be stored in the image table 314.
Message video payload 508: video data, captured by a camera component or retrieved from a memory component of the user system 102, and that is included in the message 500. Video data for a sent or received message 500 may be stored in the video table 312.
Message audio payload 510: audio data, captured by a microphone or retrieved from a memory component of the user system 102, and that is included in the message 500.
Message digital effect data 512: digital effect data (e.g., filters, stickers, or other annotations or enhancements) that represents digital effects to be applied to message image payload 506, message video payload 508, or message audio payload 510 of the message 500. Digital effect data for a sent or received message 500 may be stored in the digital effect table 310.
Message duration parameter 514: parameter value indicating, in seconds, the amount of time for which content of the message (e.g., the message image payload 506, message video payload 508, message audio payload 510) is to be presented or made accessible to a user via the interaction client 104.
Message geolocation parameter 516: geolocation data (e.g., latitudinal, and longitudinal coordinates) associated with the content payload of the message. Multiple message geolocation parameter 516 values may be included in the payload, each of these parameter values being associated with respect to content items included in the content (e.g., a specific image within the message image payload 506, or a specific video in the message video payload 508).
Message collection identifier 518: identifier values identifying one or more content collections (e.g., “stories” identified in the collections table 316) with which a particular content item in the message image payload 506 of the message 500 is associated. For example, multiple images within the message image payload 506 may each be associated with multiple content collections using identifier values.
Message tag 520: each message 500 may be tagged with multiple tags, each of which is indicative of the subject matter of content included in the message payload. For example, where a particular image included in the message image payload 506 depicts an animal (e.g., a lion), a tag value may be included within the message tag 520 that is indicative of the relevant animal. Tag values may be generated manually, based on user input, or may be automatically generated using, for example, image recognition.
Message sender identifier 522: an identifier (e.g., a messaging system identifier, email address, or device identifier) indicative of a user of the user system 102 on which the message 500 was generated and from which the message 500 was sent.
Message receiver identifier 524: an identifier (e.g., a messaging system identifier, email address, or device identifier) indicative of a user of the user system 102 to which the message 500 is addressed.

The contents (e.g., values) of the various components of message 500 may be pointers to locations in tables within which content data values are stored. For example, an image value in the message image payload 506 may be a pointer to (or address of) a location within an image table 314. Similarly, values within the message video payload 508 may point to data stored within a video table 312, values stored within the message digital effect data 512 may point to data stored in a digital effect table 310, values stored within the message collection identifier 518 may point to data stored in a collections table 316, and values stored within the message sender identifier 522 and the message receiver identifier 524 may point to user records stored within an entity table 306.

### Digital Effects Experience System

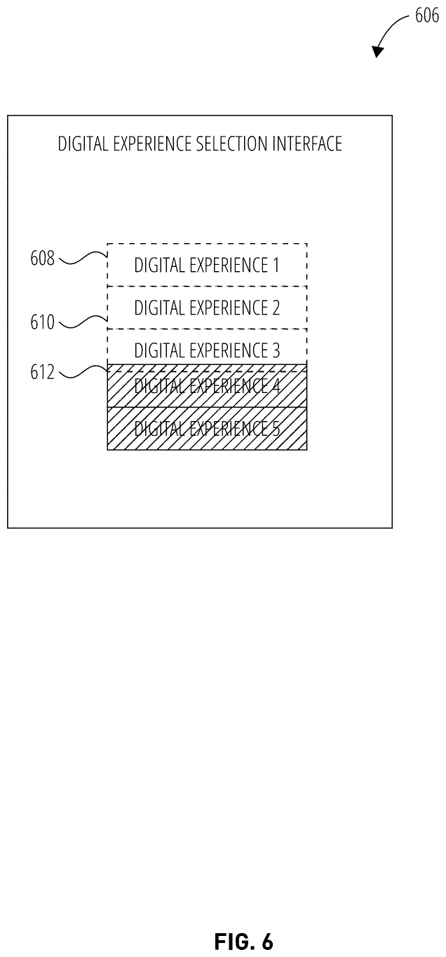

FIG. 6 illustrates a user interface of the digital effects experience generation system, according to some examples. Specifically, FIG. 6 illustrates a digital experience selection interface 606 that the user system 102 utilizes to generate content (e.g., content items including images, videos, and/or video sequences or image sequences) with digital effects associated with events and/or not associated with events. This digital experience selection interface 606 presents a list of options for accessing different digital experiences (such as first digital experience access option 608, second digital experience access option 610, and third digital experience access option 612) that users can choose from to modify their content items. The user system 102 performs several operations to generate event-associated content, including content capture using the digital effect creation system 214 using a camera of the user system 102 or selecting previously captured content from storage, and digital effect selection through the interaction client 104.

In some examples, one or more digital effects represented by the displayed options can be associated with respective events. For example, the first digital experience access option 608 may be linked to New Year's Day, while second digital experience access option 610 could be associated with Valentine's Day. These digital effects can be visually distinguished through unique icons, color schemes, or labels that clearly indicate the associated event. For example, the third digital experience access option 612 can represent an event that is approaching with a start time that is less than a threshold amount of time from a current time. In such cases, the third digital experience access option 612 can be visually distinguished from the first digital experience access option 608 to draw a user's attention to the third digital experience access option 612.

The digital effect system 206 (also referred to as the disclosed system) can maintains an event database 402 (similar to the one shown in FIG. 4) that maps events to their associated digital effects, geographical regions, and time periods. The event notification component 234 can dynamically update the available digital experiences presented in the digital experience selection interface 606 based on upcoming events, making them accessible within a specified time frame (e.g., 24 hours before the event start time). The system may also use the user's geographical location to present region-specific event effects. For example, the user system 102 can determine that a geographical location of the user system 102 is within a threshold distance of the second geographical region 424. In such cases, the user system 102 includes a digital effect option associated with the second event 420 when the current time is within a threshold period of time of the second start time 426 corresponding to the second event 420. The user system 102 can exclude digital effects from being presented in the digital experience selection interface 606 when such digital effects are associated with events that have geographical regions stored in the list of geographical regions 408 that are beyond a threshold distance of the current location of the user system 102.

For augmented reality effects, the digital effect system 206 leverages technologies like ARKit (iOS) or ARCore (Android) to implement real-time face tracking and 3D object placement. These frameworks provide optimized computer vision algorithms and motion tracking capabilities, enabling precise facial feature detection and spatial mapping for AR content. The digital effect system 206 utilizes GPU-accelerated rendering techniques to apply effects in real-time, which significantly enhances performance by offloading complex graphical computations to the device's graphics processing unit. This approach allows for parallel processing of visual effects, resulting in faster rendering times and reduced CPU load. The GPU acceleration enables the system to maintain high frame rates while applying computationally intensive effects, such as real-time facial deformations or environmental interactions. This technical optimization ensures that users experience minimal latency between their actions and the corresponding visual feedback, contributing to a fluid and responsive interface. The selection interface is implemented with gesture recognition algorithms that detect and interpret touch inputs such as swipes or taps. These algorithms analyze touch data in real-time, allowing users to navigate through available effects using intuitive gestures. The carousel-style selection mechanism is likely implemented using efficient data structures and rendering techniques that dynamically load and unload effect previews as users scroll, optimizing memory usage and maintaining smooth scrolling performance even with a large number of available effects.

After content creation, the user can post and share the modified content. The content is submitted through the interaction client 104 and sent to the digital interaction system 100, where it's processed and stored in the appropriate database tables (e.g., image table 314, video table 312, digital effect table 310). The event notification component 234 modifies the notification icon for the posted content to include an event indicator, such as by adding a holiday-specific emoji and/or changing the ring (or border around the indicator or icon) color around the notification icon. The notification icon can include a profile picture of associated with the user or user account from which the corresponding content was received and/or captured.

The modified content notification icon becomes visible to other users, who see the event-modified icon in their feeds or story lists. When another user selects the modified icon, the content item with the event-associated digital effect is presented on their user system. This comprehensive approach allows for a dynamic, engaging user experience that encourages event-themed content creation and fosters a sense of community around shared cultural moments.

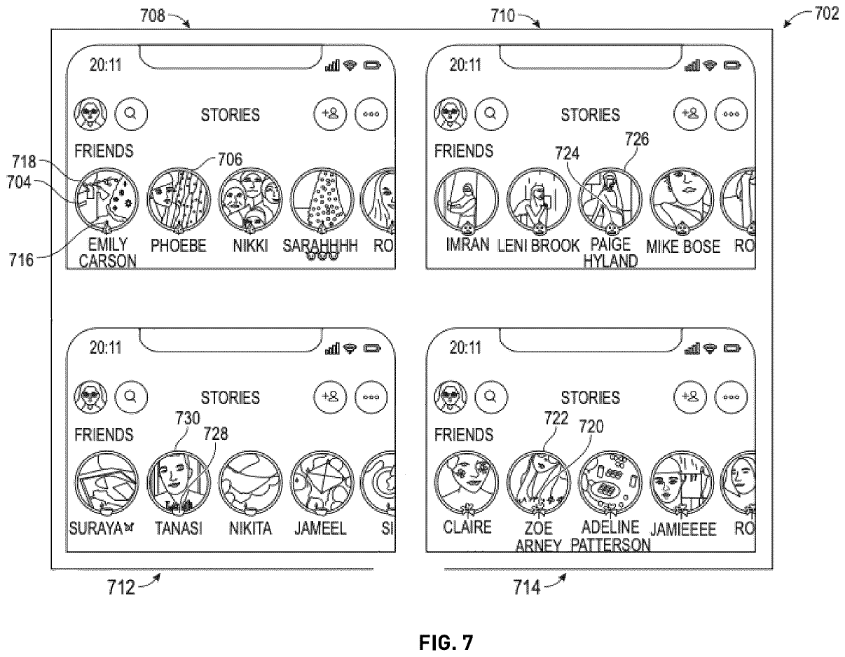

FIG. 7 illustrates graphical user interfaces generated by the event notification component 234, according to some examples. Specifically, FIG. 7 illustrates graphical user interfaces 702 displaying various configurations of a social media or messaging application's interface of the interaction client 104. FIG. 7 showcases four different GUI layouts (first GUI 708, second GUI 710, third GUI 712, and fourth GUI 714), each presenting a unique arrangement of icons and user information.

At the top of each GUI, there are icons, such as first icon 704 and second icon 706 that can represent user profile pictures or story thumbnails, indicating available stories or active users. Each GUI displays a consistent layout with a time indicator “20:11” at the top, followed by a “Stories” section with a “+” indicator suggesting additional available stories, and a “Friends” list below.

The graphical indicators (such as graphical indicator 716, graphical indicator 720, graphical indicator 724, and graphical indicator 728) appear as modifications to the standard circular notification icons relating to content posted by a user's friends. These indicators can include emojis or small graphics placed adjacent to or on top of the notification icon, potentially signifying event-related content or special status. For example, the graphical indicators could be holiday-specific emojis automatically applied by the event notification component to highlight users who have shared event-related content (e.g., content items to which event-related digital effects have been applied). Such graphical indicators may only be presented with the notification icons when the start time of the corresponding event is within a threshold period of time (e.g., 24-hours) of the current time. Then, after the end time of the event, the graphical indicators are removed leaving only the notification icons without the graphical indicators.

In some cases, rings (such as, ring 718, 722, 726, and ring 730 or other suitable shape) are colorful or stylized borders surrounding the circular content notification icons. These rings visually correspond to the adjacent graphical indicators, further emphasizing the special status or event-related content associated with that user's profile or story. In some examples, the color of these rings are derived from the primary color of the event-specific emoji. Such rings are presented with the notification icons when the start time of the corresponding event is within a threshold period of time (e.g., 24-hours) of the current time. Then, after the end time of the event, the rings are removed leaving only the notification icons without the graphical indicators. In some cases, the graphical indicators are removed when the current time is past the end time of the event by a first amount (e.g., 10 hours after the end time of the event) leaving only the rings displayed on the content notification icons. Then, the rings are removed when the current time is past the end time of the event by a second amount (e.g., 24 hours after the end time of the event).

These graphical elements (indicators and rings) serve to visually distinguish certain users or content within the friends list. They can be automatically applied by the event notification component 234 to highlight users who have shared event-related content or to indicate ongoing events relevant to specific users. The event notification component 234 can modify the icons to include event indicators (e.g., graphical indicators and/or rings) when event conditions are satisfied (e.g., the event start time is within a threshold amount of time of the current time and a current location of the user system 102 (of the user who posts the content and/or the user who is consuming or viewing the content) is within a threshold range of the geographical location associated with the event).

The varying layouts and user lists across the four GUIs demonstrate how the interface can adapt to display different groups of friends or contacts while maintaining a consistent overall structure. This flexibility allows for personalized content presentation while preserving a unified design approach, showcasing how the system can tailor the user experience based on events, user interactions, and potentially geographical regions as described in the event database 402.

In some examples, the event notification component 234 receives content items from multiple user accounts associated with different user systems 102. Some content items can be generated using event-related digital effects while others may not. The event notification component 234 can generate the graphical user interfaces 702 presented to recipient devices, such as on a user system 102 of a recipient. The event notification component 234 can, for example, present notification icons representing each content item that was received from the different user accounts, which may be associated with (e.g., friends) with the recipient on the messaging system 210. The icons can include a miniaturized picture or image of the profile picture of each user account to inform the recipient of the identity of the user account that is associated with each notification icon. The event notification component 234 can receive input that taps or otherwise selects a particular notification icon. In response, the event notification component 234 can access the corresponding content item and begin playing back the content item. When the content item completes playback, the event notification component 234 returns the recipient to the graphical user interfaces 702 showing other notification icons. In some cases, the event notification component 234 can remove or change the order of the notification icons that are presented in response to playing back the content associated with a selected notification icon.

In some examples, the event notification component 234 can process content items associated with each notification icon. The event notification component 234 can detect that a particular content item has been created using one or more digital effects that are associated with a particular event. In such cases, the event notification component 234 can access the event database 402 and find the particular event that corresponds to the digital effects used to generate the particular content item. The event notification component 234 can retrieve the start time of the event. The event notification component 234 can compare the current time with the start time of the event and determine whether the current time is within a threshold amount of time of the start time (e.g., whether the event starts in less than 24 hours).

In such cases, the event notification component 234 can retrieve one or more of the graphical indicators stored in the event database 402 for the event. For example, the event notification component 234 can select a random graphical indicator from a list of graphical indicators associated with the event. The event notification component 234 can then append or overlay the selected graphical indicator on the notification icon. In addition, the event notification component 234 can also determine a visual attribute of the selected graphical indicator (e.g., a primary color of the selected graphical indicator). The event notification component 234 can generate a ring or border having the same or similar visual attribute (e.g., primary color) and add the generated border (e.g., a ring) around the corresponding notification icon. Once the event notification component 234 determines that the end time of the event has been reached or after a threshold period of time from the end time of the event, the event notification component 234 removes the graphical indicator and/or the ring from the notification icon.

For example, the event notification component 234 can present the first GUI 708 to a recipient. The first GUI 708 can include first icon 704 and second icon 706. The first icon 704 and second icon 706 can include a notification icon that has been modified to represent a corresponding first event. This is the case because the event notification component 234 determines that the associated content item was generated using digital effects associated with the first event. Namely, the event notification component 234 can present the graphical indicator 716 (e.g., a first emoji) corresponding to the first event along with the ring 718 which has the same or similar visual attribute as the graphical indicator 716. Similarly, the event notification component 234 can present a different graphical indicator (e.g., a second emoji) corresponding to the first event along with a ring which has the same or similar visual attribute as the graphical indicator for the second icon 706. The event notification component 234 can receive input that selects the first icon 704 and, in response, the event notification component 234 accesses and plays back the content item that includes the corresponding event-based digital effect on the user system 102 of the recipient user.

As another example, the event notification component 234 can present the second GUI 710 to a recipient. The second GUI 710 can include icons similar to the first icon 704 and second icon 706. These icons (e.g., the first icon 704 and the second icon 706) can include notification icons that have been modified to represent a corresponding second event. This occurs because the event notification component 234 determines that the associated content items were generated using digital effects associated with the second event. Specifically, the event notification component 234 can present the graphical indicator 724 (e.g., a second emoji) corresponding to the second event along with the ring 726 which has the same or similar visual attribute as the graphical indicator 724. The event notification component 234 can receive input that selects an icon in the second GUI 710 and, in response, the event notification component 234 accesses and plays back the content item that includes the corresponding event-based digital effect on the user system 102 of the recipient user.

As another example, the event notification component 234 presents the third GUI 712 to a recipient. The third GUI 712 includes icons similar to the first icon 704 and second icon 706. These icons include notification icons that have been modified to represent a corresponding third event. The notification icons have been modified because the event notification component 234 determines that the associated content items were generated using digital effects associated with the third event. Specifically, the event notification component 234 presents the graphical indicator 728 (e.g., a third emoji) corresponding to the third event along with the ring 730 which has the same or similar visual attribute as the graphical indicator 728.

As another example, the event notification component 234 presents the fourth GUI 714 to a recipient. The fourth GUI 714 includes icons similar to the first icon 704 and second icon 706. These icons include notification icons that have been modified to represent a corresponding fourth event. The notification icons have been modified because the event notification component 234 determines that the associated content items were generated using digital effects associated with the fourth event. Specifically, the event notification component 234 presents the graphical indicator 720 (e.g., a fourth emoji) corresponding to the fourth event along with the ring 722 which has the same or similar visual attribute as the graphical indicator 720. The selection of this particular graphical indicator 728 is based on the content creator's user account being associated with a certain type of subscription status. For instance, premium subscribers might have access to exclusive event-related graphical indicators that are not available to standard users, allowing for a more personalized and distinctive representation of their event-related content.

In some cases, the event notification component 234 presents the third GUI 712 and the fourth GUI 714 to different recipients on the same date, but with distinct graphical indicators on the notification icons. This difference is due to the recipients'locations experiencing separate events on that date. For the third GUI 712, the event notification component 234 modifies notification icons to represent a third event specific to one geographical region. These modifications occur because the component determines that the associated content items were created using digital effects linked to the third event in that region. Specifically, it displays the graphical indicator 724 (e.g., a third emoji) for the third event, along with the ring 726, which shares visual attributes with the indicator. Concurrently, for the fourth GUI 714 associated with a different geographical location, the event notification component 234 displays the graphical indicator 728 (e.g., a fourth emoji) corresponding to a fourth event specific to that region. This indicator is accompanied by the ring 730, which visually matches the graphical indicator 728. This variation in graphical indicators between GUIs 712 and 714 demonstrates the system's capability to customize event-related content based on geographical regions, as defined in the event database structure. This approach allows for location-specific event representations within the user interface.

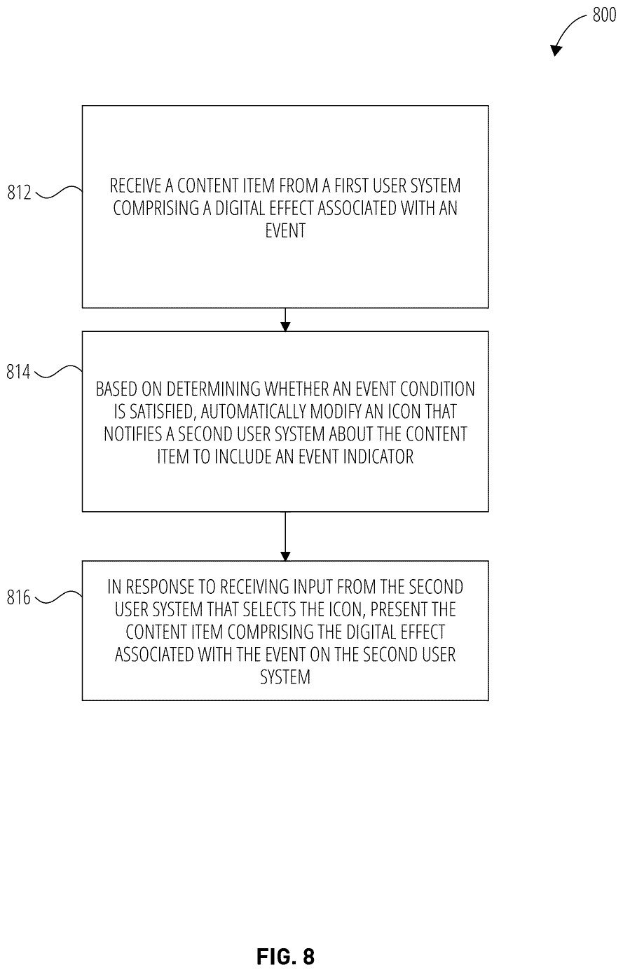

FIG. 8 is a flowchart illustrating routine 800 (e.g., a method or process), according to some examples. Although the example method depicted in FIG. 8 depicts a particular sequence of operations, the sequence may be altered without departing from the scope of the present disclosure. For example, some of the operations depicted may be performed in parallel or in a different sequence that does not materially affect the function of the method. In some examples, different components of an example device or system that implements the method may perform functions at substantially the same time or in a specific sequence.

In operation 812, the event notification component 234 receives a content item from a first user system comprising a digital effect associated with an event, as discussed above.

In operation 814, the event notification component 234, based on determining whether the event condition is satisfied, automatically modifies an icon that notifies a second user system about the content item to include an event indicator, as discussed above.

In operation 816, the event notification component 234, in response to receiving input from the second user system that selects the icon, presents the content item comprising the digital effect associated with the event on the second user system, as discussed above.

### System With Head-Wearable Apparatus

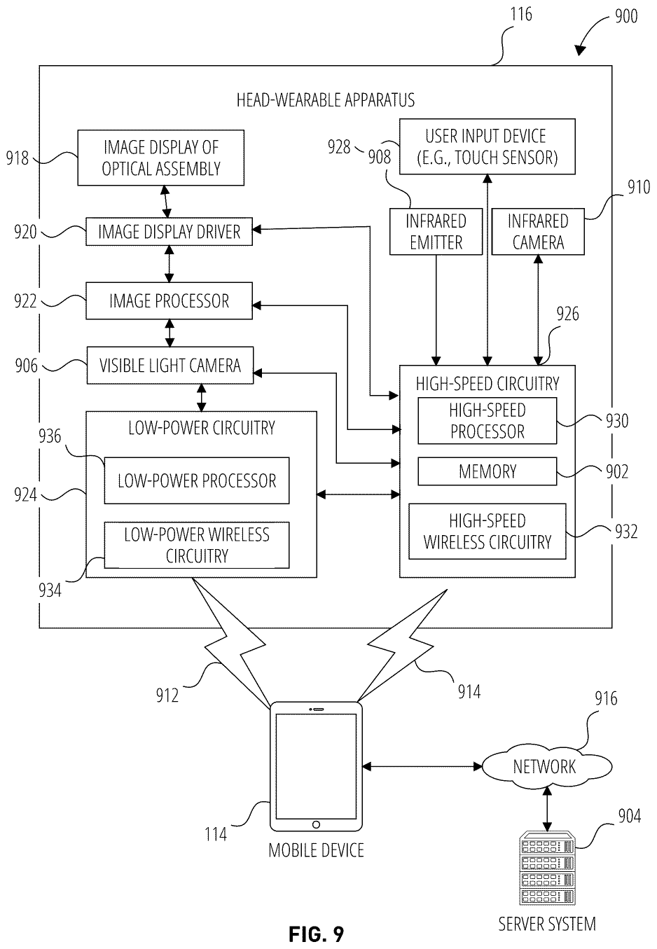

FIG. 9 illustrates a system 900 including a head-wearable apparatus 116 with a selector input device, according to some examples. FIG. 9 is a high-level functional block diagram of an example head-wearable apparatus 116 communicatively coupled to a mobile device 114 and various server systems 904 (e.g., the server system 110) via various networks.

The head-wearable apparatus 116 includes one or more cameras, each of which may be, for example, a visible light camera 906, an infrared emitter 908, and an infrared camera 910.

The mobile device 114 connects with head-wearable apparatus 116 using both a low-power wireless connection 912 and a high-speed wireless connection 914. The mobile device 114 is also connected to the server system 904 and the Network 916.

The head-wearable apparatus 116 further includes two image displays of the image display of optical assembly 918. The two image displays of optical assembly 918 include one associated with the left lateral side and one associated with the right lateral side of the head-wearable apparatus 116. The head-wearable apparatus 116 also includes an image display driver 920, an image processor 922, low-power circuitry 924, and high-speed circuitry 926. The image display of optical assembly 918 is for presenting images and videos, including an image that can include a graphical user interface to a user of the head-wearable apparatus 116.

The image display driver 920 commands and controls the image display of optical assembly 918. The image display driver 920 may deliver image data directly to the image display of optical assembly 918 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 116 includes a frame and stems (or temples) extending from a lateral side of the frame. The head-wearable apparatus 116 further includes a user input device 928 (e.g., touch sensor or push button), including an input surface on the head-wearable apparatus 116. The user input device 928 (e.g., touch sensor or push button) is to receive from the user an input selection to manipulate the graphical user interface of the presented image.

The components shown in FIG. 9 for the head-wearable apparatus 116 are located on one or more circuit boards, for example a PCB or flexible PCB, in the rims or temples. Alternatively, or additionally, the depicted components can be located in the chunks, frames, hinges, or bridge of the head-wearable apparatus 116. Left and right visible light cameras 906 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 116 includes a memory 902, which stores instructions to perform a subset, or all the functions described herein. The memory 902 can also include storage device.

As shown in FIG. 9, the high-speed circuitry 926 includes a high-speed processor 930, a memory 902, and high-speed wireless circuitry 932. In some examples, the image display driver 920 is coupled to the high-speed circuitry 926 and operated by the high-speed Processor 930 to drive the left and right image displays of the image display of optical assembly 918. The high-speed Processor 930 may be any processor capable of managing high-speed communications and operation of any general computing system needed for the head-wearable apparatus 116. The high-speed Processor 930 includes processing resources needed for managing high-speed data transfers on a high-speed wireless connection 914 to a wireless local area network (WLAN) using the high-speed wireless circuitry 932. In certain examples, the high-speed Processor 930 executes an operating system such as a LINUX operating system or other such operating system of the head-wearable apparatus 116, and the operating system is stored in the memory 902 for execution. In addition to any other responsibilities, the high-speed Processor 930 executing a software architecture for the head-wearable apparatus 116 is used to manage data transfers with high-speed wireless circuitry 932. In certain examples, the high-speed wireless circuitry 932 is configured to implement Institute of Electrical and Electronic Engineers (IEEE) 802.11 communication standards, also referred to herein as WI-FI®. In some examples, other high-speed communications standards may be implemented by the high-speed wireless circuitry 932.

The low-power wireless circuitry 934 and the high-speed wireless circuitry 932 of the head-wearable apparatus 116 can include short-range transceivers (e.g., Bluetooth™, Bluetooth LE, Zigbee, ANT+) and wireless wide, local, or wide area Network transceivers (e.g., cellular or WI-FI®). Mobile device 114, including the transceivers communicating via the low-power wireless connection 912 and the high-speed wireless connection 914, may be implemented using details of the architecture of the head-wearable apparatus 116, as can other elements of the Network 916.

The memory 902 includes any storage device capable of storing various data and applications, including, among other things, camera data generated by the left and right visible light cameras 906, the infrared camera 910, and the image processor 922, as well as images generated for display by the image display driver 920 on the image displays of the image display of optical assembly 918. While the memory 902 is shown as integrated with high-speed circuitry 926, in some examples, the memory 902 may be an independent standalone element of the head-wearable apparatus 116. In certain such examples, electrical routing lines may provide a connection through a chip that includes the high-speed Processor 930 from the image processor 922 or the low-power Processor 936 to the memory 902. In some examples, the high-speed Processor 930 may manage addressing of the memory 902 such that the low-power processor 936 will boot the high-speed Processor 930 any time that a read or write operation involving memory 902 is needed.

As shown in FIG. 9, the low-power Processor 936 or high-speed Processor 930 of the head-wearable apparatus 116 can be coupled to the camera (visible light camera 906, infrared emitter 908, or infrared camera 910), the image display driver 920, the user input device 928 (e.g., touch sensor or push button), and the memory 902.

The head-wearable apparatus 116 is connected to a host computer. For example, the head-wearable apparatus 116 is paired with the mobile device 114 via the high-speed wireless connection 914 or connected to the server system 904 via the Network 916. The server system 904 may be one or more computing devices as part of a service or network computing system, for example, that includes a processor, a memory, and network communication interface to communicate over the Network 916 with the mobile device 114 and the head-wearable apparatus 116.

The mobile device 114 includes a processor and a network communication interface coupled to the processor. The Network communication interface allows for communication over the Network 916, low-power wireless connection 912, or high-speed wireless connection 914. Mobile device 114 can further store at least portions of the instructions in the memory of the mobile device 114 memory to implement the functionality described herein.

Output components of the head-wearable apparatus 116 include visual components, such as a liquid crystal display (LCD), a plasma display panel (PDP), a light-emitting diode (LED) display, a projector, or a waveguide. The image displays of the optical assembly are driven by the image display driver 920. The output components of the head-wearable apparatus 116 further include acoustic components (e.g., speakers), haptic components (e.g., a vibratory motor), other signal generators, and so forth. The input components of the head-wearable apparatus 116, the mobile device 114, and server system 904, such as the user input device 928, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 116 may also include additional peripheral device elements. Such peripheral device elements may include sensors and display elements integrated with the head-wearable apparatus 116. For example, peripheral device elements may include any I/O components including output components, motion components, position components, or any other such elements described herein.

In some examples, the head-wearable apparatus 116 may include biometric components or sensors s to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored with only user approval and deleted on user request, and in accordance with applicable laws.

Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the biometric data is not shared or sold to any third party without the explicit consent of the user. In addition, appropriate technical and organizational measures are implemented to ensure the security and confidentiality of this sensitive information.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 912 and high-speed wireless connection 914 from the mobile device 114 via the low-power wireless circuitry 934 or high-speed wireless circuitry 932.

### Machine Architecture

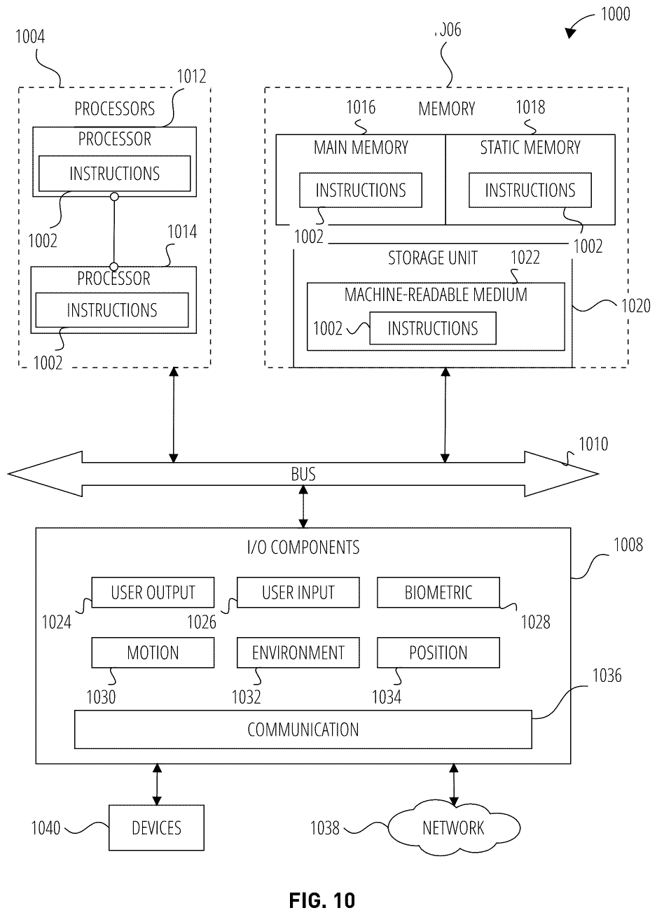

FIG. 10 is a diagrammatic representation of the machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. The machine 1000, for example, may comprise the user system 102 or any one of multiple server devices forming part of the server system 110. In some examples, the machine 1000 may also comprise both client and server systems, with certain operations of a particular method or algorithm being performed on the server-side and with certain operations of the method or algorithm being performed on the client-side.

The machine 1000 may include processors 1004, memory 1006, and input/output I/O components 1008, which may be configured to communicate with each other via a bus 1010.

The memory 1006 includes a main memory 1016, a static memory 1018, and a storage unit 1020, both accessible to the processors 1004 (e.g., processor 1012 or processor 1014 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the Processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1008 may include biometric components 1028, motion components 1030, environmental components 1032, or position components 1034, among a wide array of other components. For example, the biometric components 1028 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request, and in accordance with applicable laws.

Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1030 include acceleration sensor components (e.g., accelerometer), gravitation sensor components, rotation sensor components (e.g., gyroscope).

The environmental components 1032 include, for example, one or more cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be modified with digital effect data (e.g., filters) described above. The rear cameras may, for example, be used to capture still images and videos in a more traditional camera mode, with these images similarly being modified with digital effect data. In addition to front and rear cameras, the user system 102 may also include a 360° camera for capturing 360° photographs and videos.

Moreover, the camera system of the user system 102 may be equipped with advanced multi-camera configurations. This may include dual rear cameras, which may consist of a primary camera for general photography and a depth-sensing camera for capturing detailed depth information in a scene. This depth information can be used for various purposes, such as creating a bokeh effect in portrait mode, where the subject is in sharp focus while the background is blurred. In addition to dual camera setups, the user system 102 may also feature triple, quad, or even penta camera configurations on both the front and rear sides of the user system 102. These multiple cameras systems may include a wide camera, an ultra-wide camera, a telephoto camera, a macro camera, and a depth sensor, for example.

Communication may be implemented using a wide variety of technologies. The I/O components 1008 further include communication components 1036 operable to couple the machine 1000 to a Network 1038 or devices 1040 via respective coupling or connections. For example, the communication components 1036 may include a network interface component or another suitable device to interface with the Network 1038. In further examples, the communication components 1036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1040 may be another machine or any of a wide variety of peripheral devices (e.g., a peripheral device coupled via a USB).

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the Processors 1004) and storage unit 1020 may store one or more sets of instructions and data structures (e.g., software) embodying or used by any one or more of the methodologies or functions described herein. These instructions (e.g., the instructions 1002), when executed by Processors 1004, cause various operations to implement the disclosed examples.

The instructions 1002 may be transmitted or received over the Network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

### Software Architecture

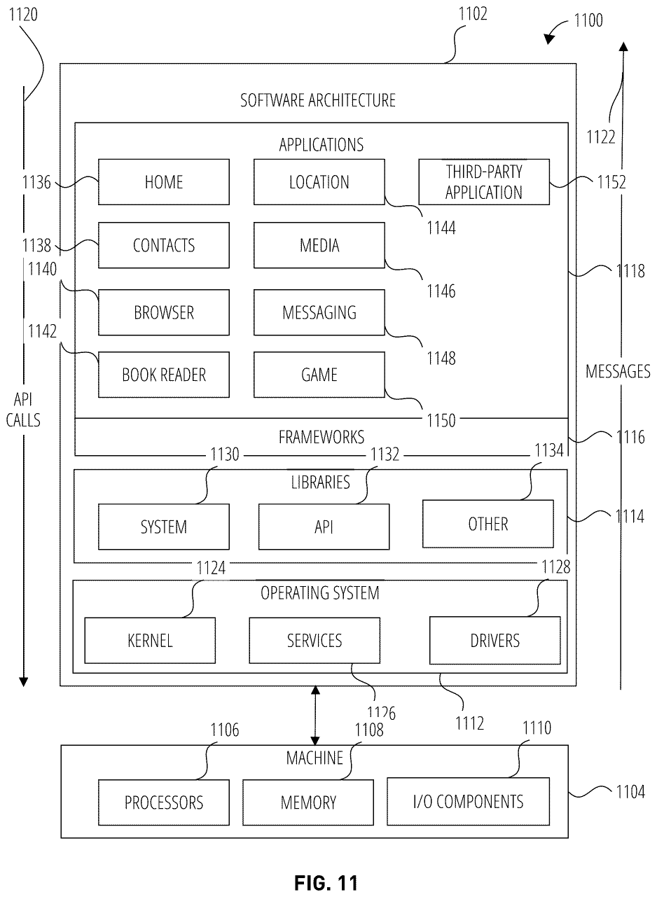

FIG. 11 is a block diagram 1100 illustrating a software architecture 1102, which can be installed on any one or more of the devices described herein. The software architecture 1102 is supported by hardware such as a machine 1104 that includes Processors 1106, memory 1108, and I/O components 1110. In this example, the software architecture 1102 can be conceptualized as a stack of layers, where each layer provides a particular functionality.

The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematical functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ software development kit (SDK) by an entity other than the vendor of a platform) may be mobile software running on a mobile operating system such as IOS™, ANDROID™, WINDOWS® Phone, or another mobile operating system. In this example, the third-party application 1152 can invoke the API calls 1120 provided by the operating system 1112 to facilitate functionalities described herein.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### EXAMPLE STATEMENTS

Example 1. A system comprising: at least one processor; at least one memory component storing instructions that, when executed by the at least one processor, cause the at least one processor to perform operations comprising: receiving a content item from a first user system comprising a digital effect associated with an event; determining whether an event condition is satisfied; based on determining whether the event condition is satisfied, automatically modifying an icon that notifies a second user system about the content item to include an event indicator; and in response to receiving input from the second user system that selects the icon, presenting the content item comprising the digital effect associated with the event on the second user system.

Example 2. The system of Example 1, wherein the first user system is associated with a first user, and wherein the second user system is associated with a second user that is associated with the first user.

Example 3. The system of Example 2, wherein the second user is friends with the first user on an interaction application.

Example 4. The system of any one of Examples 1-3, wherein the operations for determining whether the event condition is satisfied comprise: determining that a current time is within a threshold period of a start time of the event; and in response to determining that the current time is within the threshold period of the start time of the event, determining that the event condition is satisfied.

Example 5. The system of Example 4, wherein the operations comprise: determining a geographical region associated with the first user system; identifying a plurality of events associated with the geographical region; retrieving start times for each of the plurality of events; and determining that the current time is within the threshold period of the start time of an individual event of the plurality of events.

Example 6. The system of any one of Examples 4-5, wherein the threshold period of time comprises 24 hours prior to the start time of the event.

Example 7. The system of any one of Examples 4-6, wherein the operations comprise: determining that the event condition is no longer satisfied after the icon has been modified to include the event indicator; and in response to determining that the event condition is no longer satisfied after the icon has been modified to include the event indicator, removing the event indicator from the icon.

Example 8. The system of any one of Examples 1-7, wherein the event comprises a holiday.

Example 9. The system of any one of Examples 1-8, wherein the operations comprise: receiving input from the first user system to capture one or more images using an image capture device; receiving additional input from the first user system that selects one or more digital effects from a plurality of digital effects associated with the event; and modifying the one or more images using the selected one or more digital effects to generate the content item.

Example 10. The system of any one of Examples 1-9, wherein the content item comprises a sequence of videos, the videos being played back according to the sequence in response to being accessed on the second user system.

Example 11. The system of any one of Examples 1-10, wherein the icon comprises a circular icon, and wherein modifying the icon comprises adding an individual graphical indicator adjacent to the circular icon.

Example 12. The system of Example 11, wherein the individual graphical indicator comprises an emoji.

Example 13. The system of Example 12, wherein the operations comprise: adding a ring around the circular icon, the ring having a visual property corresponding to a visual property of the emoji.

Example 14. The system of any one of Examples 11-13, wherein the operations comprise: identifying a plurality of graphical indicators associated with the event; and randomly selecting the individual graphical indicator from the plurality of graphical indicators.

Example 15. The system of any one of Examples 11-14, wherein the operations comprise: identifying a plurality of graphical indicators associated with the event; detecting a subscription status associated a user account corresponding to the first user system; and selecting the individual graphical indicator from the plurality of graphical indicators based on the subscription status associated with the user account.

Example 16. The system of any one of Examples 1-15, wherein the digital effect comprises an augmented reality item or sticker used to modify one or more images comprising the content item.

Example 17. A computer-implemented method comprising: receiving a content item from a first user system comprising a digital effect associated with an event; determining whether an event condition is satisfied; based on determining whether the event condition is satisfied, automatically modifying an icon that notifies a second user system about the content item to include an event indicator; and in response to receiving input from the second user system that selects the icon, presenting the content item comprising the digital effect associated with the event on the second user system.

Example 18. The computer-implemented method of Example 17, wherein the first user system is associated with a first user, and wherein the second user system is associated with a second user that is associated with the first user.

Example 19. The computer-implemented method of Example 18, wherein the second user is friends with the first user on an interaction application.

Example 20. A non-transitory computer-readable storage medium storing instructions that, when executed by at least one processor, cause the at least one processor to perform operations comprising: receiving a content item from a first user system comprising a digital effect associated with an event; determining whether an event condition is satisfied; based on determining whether the event condition is satisfied, automatically modifying an icon that notifies a second user system about the content item to include an event indicator; and in response to receiving input from the second user system that selects the icon, presenting the content item comprising the digital effect associated with the event on the second user system.

### TERM EXAMPLES

“Carrier signal” may include, for example, any intangible medium that can store, encoding, or carrying instructions for execution by the machine and includes digital or analog communications signals or other intangible media to facilitate communication of such instructions. Instructions may be transmitted or received over a network using a transmission medium via a network interface device.

“Client device” may include, for example, any machine that interfaces to a network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” may include, for example, a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations.

A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors.

Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time.

For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein.

As used herein, “processor-implemented component” may refer to a hardware component implemented using one or more processors. Similarly, the methods described herein may be at least partially Processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” may include, for example, both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Machine storage medium” may include, for example, a single or multiple storage devices and media (e.g., a centralized or distributed database, and associated caches and servers) that store executable instructions, routines, and data. The term shall accordingly be taken to include, but not be limited to, solid-state memories, and optical and magnetic media, including memory internal or external to processors. Specific examples of machine-storage media, computer-storage media, and device-storage media include non-volatile memory, including by way of example semiconductor memory devices, e.g., erasable programmable read-only memory (EPROM), electrically erasable programmable read-only memory (EEPROM), Field-Programmable Gate Arrays (FPGA), flash memory devices, Solid State Drives (SSD), and Non-Volatile Memory Express (NVMe) devices; magnetic disks such as internal hard disks and removable disks; magneto-optical disks; and CD-ROM, DVD-ROM, Blu-ray Discs, and Ultra HD Blu-ray discs. In addition, machine storage medium may also refer to cloud storage services, Network Attached Storage (NAS), Storage Area Networks (SAN), and object storage devices. The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” may include, for example, a tangible medium that is capable of storing, encoding, or carrying the instructions for execution by a machine.

“Processor” may include, for example, data processors such as a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), a Quantum Processing Unit (QPU), a Tensor Processing Unit (TPU), a Neural Processing Unit (NPU), a Field Programmable Gate Array (FPGA), another processor, or any suitable combination thereof. The term “processor” may include multi-core processors that may comprise two or more independent processors (sometimes referred to as “cores”) that may execute instructions contemporaneously. These cores can be homogeneous (e.g., all cores are identical, as in multicore CPUs) or heterogeneous (e.g., cores are not identical, as in many modern GPUs and some CPUs). In addition, the term “processor” may also encompass systems with a distributed architecture, where multiple processors are interconnected to perform tasks in a coordinated manner. This includes cluster computing, grid computing, and cloud computing infrastructures. Furthermore, the processor may be embedded in a device to control specific functions of that device, such as in an embedded system, or it may be part of a larger system, such as a server in a data center. The processor may also be virtualized in a software-defined infrastructure, where the processor's functions are emulated in software.

“Signal medium” may include, for example, an intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” may include, for example, a device accessed, controlled or owned by a user and with which the user interacts perform an action, engagement or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
receiving a content item from a first user system comprising a digital effect associated with an event;
determining whether an event condition is satisfied;
based on determining whether the event condition is satisfied, automatically modifying an icon that notifies a second user system about the content item to include an event indicator; and
in response to receiving input from the second user system that selects the icon, presenting the content item comprising the digital effect associated with the event on the second user system.

2. The system of claim 1, wherein the first user system is associated with a first user, and wherein the second user system is associated with a second user that is associated with the first user.

3. The system of claim 2, wherein the second user is friends with the first user on an interaction application.

4. The system of claim 1, wherein the operations for determining whether the event condition is satisfied comprise:
determining that a current time is within a threshold period of a start time of the event; and
in response to determining that the current time is within the threshold period of the start time of the event, determining that the event condition is satisfied.

5. The system of claim 4, wherein the operations comprise:
determining a geographical region associated with the first user system;
identifying a plurality of events associated with the geographical region;
retrieving start times for each of the plurality of events; and
determining that the current time is within the threshold period of the start time of an individual event of the plurality of events.

6. The system of claim 4, wherein the threshold period of time comprises 24 hours prior to the start time of the event.

7. The system of claim 4, wherein the operations comprise:
determining that the event condition is no longer satisfied after the icon has been modified to include the event indicator; and
in response to determining that the event condition is no longer satisfied after the icon has been modified to include the event indicator, removing the event indicator from the icon.

8. The system of claim 1, wherein the event comprises a holiday.

9. The system of claim 1, wherein the operations comprise:
receiving input from the first user system to capture one or more images using an image capture device;
receiving additional input from the first user system that selects one or more digital effects from a plurality of digital effects associated with the event; and
modifying the one or more images using the selected one or more digital effects to generate the content item.

10. The system of claim 1, wherein the content item comprises a sequence of videos, the videos being played back according to the sequence in response to being accessed on the second user system.

11. The system of claim 1, wherein the icon comprises a circular icon, and wherein modifying the icon comprises adding an individual graphical indicator adjacent to the circular icon.

12. The system of claim 11, wherein the individual graphical indicator comprises an emoji.

13. The system of claim 12, wherein the operations comprise:
adding a ring around the circular icon, the ring having a visual property corresponding to a visual property of the emoji.

14. The system of claim 11, wherein the operations comprise:
identifying a plurality of graphical indicators associated with the event; and
randomly selecting the individual graphical indicator from the plurality of graphical indicators.

15. The system of claim 11, wherein the operations comprise:
identifying a plurality of graphical indicators associated with the event;
detecting a subscription status associated a user account corresponding to the first user system; and
selecting the individual graphical indicator from the plurality of graphical indicators based on the subscription status associated with the user account.

16. The system of claim 1, wherein the digital effect comprises an augmented reality item or sticker used to modify one or more images comprising the content item.

17. A computer-implemented method comprising:
receiving a content item from a first user system comprising a digital effect associated with an event;
determining whether an event condition is satisfied;
based on determining whether the event condition is satisfied, automatically modifying an icon that notifies a second user system about the content item to include an event indicator; and
in response to receiving input from the second user system that selects the icon, presenting the content item comprising the digital effect associated with the event on the second user system.

18. The computer-implemented method of claim 17, wherein the first user system is associated with a first user, and wherein the second user system is associated with a second user that is associated with the first user.

19. The computer-implemented method of claim 18, wherein the second user is friends with the first user on an interaction application.

20. A non-transitory computer-readable storage medium storing instructions that, when executed by at least one processor, cause the at least one processor to perform operations comprising:
receiving a content item from a first user system comprising a digital effect associated with an event;
determining whether an event condition is satisfied;
based on determining whether the event condition is satisfied, automatically modifying an icon that notifies a second user system about the content item to include an event indicator; and
in response to receiving input from the second user system that selects the icon, presenting the content item comprising the digital effect associated with the event on the second user system.
